(19) United States
(12) Patent Application Publication
(10) Pub. No.: US 2010/0078302 A1
(43) Pub. Date: Apr. 1, 2010

(54) INSULATING SWITCHING ROD WITH A CONTACT PRESSURE ARRANGEMENT COMPRISING A PLURALITY OF HELICAL COMPRESSION SPRINGS WOUND IN OPPOSITE SENSES

(75) Inventors: Thomas Erk, Senzig (DE); Ralf-Reiner Volkmar, Oldenburg i.H. (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/295,015

(22) PCT Filed: Mar. 15, 2007
(86) PCT No.: PCT/EP2007/052435

§ 371 Date: Nov. 21, 2008

(30) Foreign Application Priority Data
Mar. 29, 2006 (DE) 10 2006 015 308.1

(51) Int. Cl. H01H 5/06

(52) U.S. Cl. 200/400

(57) ABSTRACT

An insulating switching rod is used to initiate a drive movement into a moving contact of an electrical contact system of a switching device and to produce a contact force when the contact system is in the closed state. A tensioning apparatus is arranged in a cavity for a drive element of the switching rod in order to maintain the contact force, which has a greater contact force with a compact design, and ensures constant spring characteristics as well as low wear over the entire useful life. The tensioning apparatus is formed by a helical compression spring configuration or by two oppositely wound helical springs.

The invention relates to an insulating switching rod for initiating a drive movement in a moving contact of an electrical contact system of a switching device and for producing a contact force in the closed state of the contact system with a tensioning apparatus, which is arranged in a cavity, for a drive element of the switching rod for maintaining the contact force.

Such an insulating switching rod is known from the general prior art. In switching devices, such as circuit breakers, for example, with an electrical contact system arranged in a vacuum interrupter, a drive movement being initiated via a drive unit onto a moving contact of the contact system, the insulating switching rod is used firstly for DC-isolating the drive unit from the contact system and secondly for initiating the drive movement and for producing a substantially constant contact force in the closed state of the contact system. For this purpose, the insulating switching rod comprises a tensioning apparatus, which is arranged in a cavity of the switching rod and acts between a drive element and a housing of the switching rod, with the result that, in the closed state, the contact force is maintained on the contact system as a result of the tensioning apparatus. In the case of the insulating switching rod known from the general prior art, the tensioning apparatus comprises an arrangement of disk springs, by means of which the contact force is produced. Such disk springs are subject to wear as a result of erosion of the edges and, owing to their steep characteristic profile, result in considerable changes in the contact force introduced given small changes in the working excursion of the switching device.

The object of the present invention is to develop an insulating switching rod of the type mentioned at the outset in such a way that constant contact forces and a low degree of wear are ensured throughout the life.

According to the invention, this object is achieved in the case of an insulating switching rod of the type mentioned at the outset by virtue of the fact that the tensioning apparatus comprises a helical compression spring arrangement.

By means of the helical compression spring arrangement, the wear of the switching rod is advantageously considerably reduced. The helical compression spring arrangement does not have any edges, with the result that friction effects on the wall of the cavity are reduced and the wear of the springs is decreased. Furthermore, helical compression springs have a flatter characteristic in comparison with disk springs which have been conventional to date, with a comparatively constant contact force as a result.

In a preferred embodiment, the helical compression spring arrangement comprises a plurality of helical compression springs which are wound in opposite senses and are interleaved with one another. In other words, the helical compression spring arrangement is in the form of a set of helical compression springs, with the plurality of helical compression springs, which are wound in opposite senses and are interleaved with one another, overall having a high spring force. In particular, it is possible with such a helical compression spring arrangement to produce high contact forces of 3500 to 5000 N given a compact physical volume and given a working excursion between 0 and 5 mm, with the helical compression spring arrangement having a mean spring constant of 200 N/mm.

Furthermore, protection against kinking of the helical compression spring arrangement is advantageously substantially increased because the helical compression springs wound in opposite senses stabilize one another so as to prevent kinking, as a result of which the wear of the apparatus is reduced. The helical compression spring arrangement is guided, for example, by means of an inner drive bolt, which is fixedly connected to the drive element.

In a further expedient configuration, a first helical compression spring of the helical compression spring arrangement has an outer diameter which corresponds to an inner diameter of the cavity. With a first helical compression spring given such dimensions, guidance of the helical compression spring arrangement against the wall of the cavity is ensured, as a result of which the protection against kinking of the helical compression spring arrangement is increased. Owing to the bent helical configuration of the helical compression springs, wear is reduced in comparison with disk springs.

In a further expedient configuration, the drive element has a drive bolt, a second helical compression spring with an outer diameter which is smaller than the inner diameter of the first helical compression spring having an inner diameter which corresponds to an outer diameter of the drive bolt. In the case of such a second helical compression spring, guidance of the helical compression spring arrangement against the drive bolt is ensured, as a result of which the protection against kinking of the helical compression spring arrangement is furthermore increased and wear is reduced. Furthermore, with such a second helical compression spring, mutual stabilization of the first and the second helical compression springs with respect to one another is ensured, as a result of which the protection against kinking is likewise increased.

The invention will be explained in more detail below using the drawing and an exemplary embodiment with reference to the attached figures, in which:

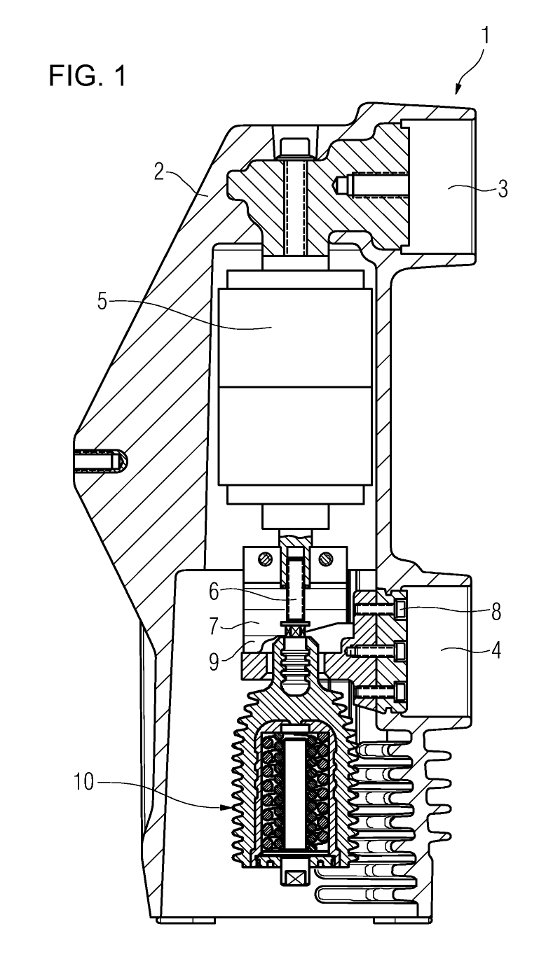

FIG. 1 shows a switch pole of a switching device with an insulating switching rod according to the invention;

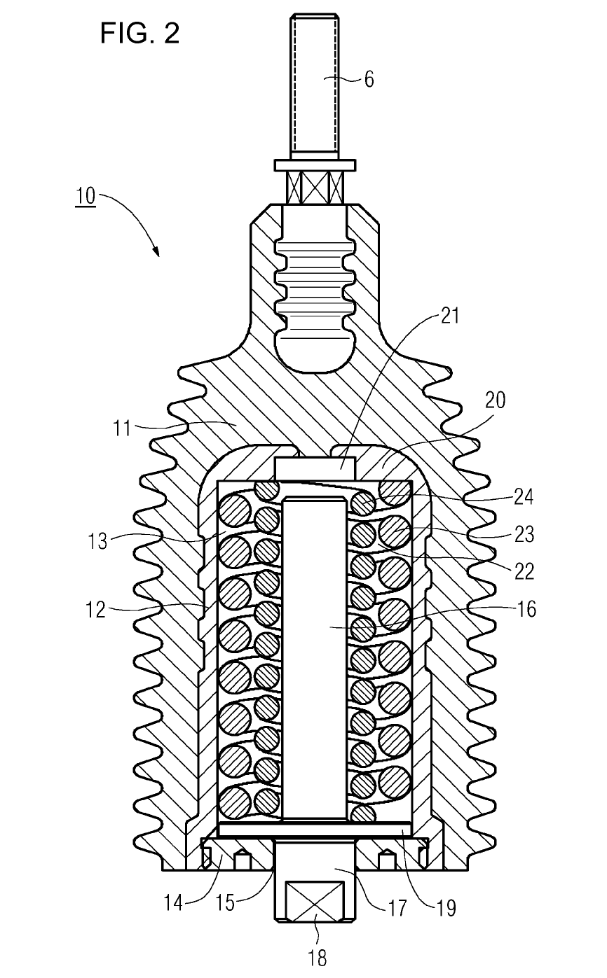

FIG. 2 shows a detail view of the insulating switching rod according to the invention.

FIG. 1 shows a switch pole 1 of a circuit breaker known per se for switching or interrupting currents of a polyphase AC system. The switch pole 1 comprises an insulating housing 2, in which a first connection piece 3 and a second connection piece 4 for connection to busbars or outgoing feeders of the switching device which are not illustrated in the figures are arranged. An electrically conductive connection via a contact system of a vacuum interrupter 5 can be produced or isolated between the first connection piece 3 and the second connection piece 4. A moving contact (not illustrated in the figures) of the vacuum interrupter 5 is in this case electrically conductively connected to the second connection piece 4 by means of a conductive connecting rod 6 via a coupling element 7 and further connecting means 8. The coupling element 7 has a flexible conductor 9 for this purpose. The connecting rod 6 is in this case part of the insulating switching rod 10, which will be explained in more detail further below with reference to FIG. 2. The insulating switching rod 10 is mechanically coupled to a drive unit (not illustrated in the figures), via which a drive movement is initiated in the moving contact of the vacuum interrupter 5.

FIG. 2 shows the insulating switching rod 10 from FIG. 1 in a detail view. The insulating switching rod 10 comprises an insulating body 11, in which the connecting rod 6 is cast. A housing part 12, which is likewise cast in the insulating body 11, has a cylindrical cavity 13, which is closed by means of a cover plate 14. A drive element 16 with the configuration of a drive bolt 16, which has a connecting part 18 at its first end 17, which connecting part is designed for connection to the drive unit of the switching device, extends through an opening 15 in the cover plate 14. The drive bolt 16 also has a flange-like section 19, which has an inner diameter which is slightly smaller than the inner diameter of the cavity 13, with the result that the drive bolt 16 is guided by means of the flange 19 against the wall of the cavity 13. The flange-like section 19 furthermore acts as a stop element for delimiting a movement of the drive bolt 16 on the cover plate 14. The length of the drive bolt 16 is in this case selected such that it substantially corresponds to the length of the cavity 13 or is slightly shorter than said cavity. The housing part 12 has a cutout 21 in a base region 20 of the cavity 13. A helical compression spring arrangement 22 with a first helical compression spring 23 and a second helical compression spring 24 is arranged in the cavity 13. The helical compression spring arrangement 22 is prestressed between the base region 20 of the cavity 13 and the flange-like section 19 of the drive bolt 16. The first helical spring 23 in this case has an outer diameter which corresponds to the inner diameter of the cavity 13, with the result that the first helical compression spring is guided on the inner wall of the cavity 13. The second helical compression spring 24 has a smaller outer diameter than the inner diameter of the first helical compression spring and an inner diameter which substantially corresponds to the outer diameter of the drive bolt 16, with the result that the second helical compression spring is guided on the drive bolt 16.

With such an insulating switching rod 10, firstly DC isolation between the drive unit and the contact system is formed in the case of a switching device since a drive movement of the drive unit is transmitted via the insulating switching rod, with no DC connection being provided between the drive bolt 16 and the connecting rod 6. Furthermore, once the drive movement has taken place for closing the contact system of the vacuum interrupter 5, a contact force is transmitted by the helical compression spring arrangement 22 of the insulating switching rod onto the moving contact in the closed state of the contact system of the vacuum interrupter 5 because, once the drive movement has taken place and the drive unit has stopped, the spring force of the helical compression spring arrangement acts on the connecting rod 6 and therefore on the moving contact of the vacuum interrupter 5 by means of the helical compression spring arrangement 22 between the flange-like section 19 via the housing part 12. As can be seen in FIG. 2, in this case protection against tipping of the spring arrangement is in particular ensured by the arrangement of a plurality of helical compression springs because the helical compression springs are guided on the drive bolt or on the inner wall of the interior 13 and stabilize one another against tipping. With such a helical compression spring arrangement, it is particularly possible to produce high contact forces of from 3500 to 5000 N given a compact physical volume and given a working excursion of between 0 and 5 mm, with the helical compression spring arrangement having a mean spring constant of 200 N/mm.

### LIST OF REFERENCE SYMBOLS

1 Switch pole
2 Insulating housing
3 First connection piece
4 Second connection piece
5 Vacuum interrupter
6 Connecting rod
7 Coupling element
8 Connecting means
9 Flexible conductor
10 Insulating switching rod
11 Insulating body
12 Housing part
13 Cavity
14 Cover plate
15 Bushing
16 Drive bolt
17 First end
18 Connecting part
19 Flange-like section
20 Base region
21 Cutout
22 Helical compression spring arrangement
23 First helical compression spring
24 Second helical compression spring

1-4. (canceled)

5. A switching rod assembly, comprising:
an insulating switching rod for injecting a drive movement into a moving contact of an electrical contact system of a switching device and for producing a contact force in a closed state of the contact system;
a drive element for said switching rod; and
a helical compression spring configuration disposed in a cavity, said spring configuration forming a tensioning apparatus for said drive element for maintaining the contact force in the closed state of the contact system.

6. The switching rod assembly according to claim 5, wherein said drive element and said a helical compression spring configuration are commonly disposed in said cavity.

7. The switching rod assembly according to claim 5, wherein said helical compression spring configuration includes a plurality of helical compression springs wound in respectively opposite senses and interleaved with one another.

8. The switching rod assembly according to claim 5, wherein said helical compression spring configuration includes a first helical compression spring having an outer diameter substantially corresponding with an inner diameter of said cavity.

9. The switching rod assembly according to claim 8, wherein said drive element includes a drive bolt and said helical compression spring configuration includes a second helical compression spring with an outer diameter smaller than an inner diameter of said first helical compression spring and with an inner diameter corresponding to an outer diameter of said drive bolt.
